(19) United States
(12) Patent Application Publication
(10) Pub. No.: US 2008/0067830 A1
(43) Pub. Date: Mar. 20, 2008

(54) MODULAR CANOPY

(76) Inventor: Robert Paul FRANKHAM, Burleigh Heads (AU)

Correspondence Address: YOUNG & THOMPSON, 745 SOUTH 23RD STREET, 2ND FLOOR, ARLINGTON, VA, 22202, US

(21) Appl. No.: 11/857,457

(22) Filed: Sep. 19, 2007

(30) Foreign Application Priority Data
Sep. 19, 2006 (AU) 2006100802

(51) Int. Cl. B60P 7/02; B60J 7/16

(52) U.S. Cl. 296/100.02

(57) ABSTRACT

A modular canopy including in combination, a plurality of modules which can be assembled together to construct a canopy for a truck or utility vehicle, the modules interchangeable to vary the size, length and configuration to suit a type of trade or business.

### FIELD OF THE INVENTION

This invention relates to canopies for trucks and utility vehicles in particular but not exclusively to a modular canopy for the attachment to a tray or flatbed of a truck or utility vehicle wherein the configuration of the canopy can be varied.

### BACKGROUND ART

The conversion of flatbed trucks or utility vehicle into a specialised work vehicle by attaching a canopy is well known.

In most cases the canopies are moulded out of fibreglass or glass reinforced plastic of a particular design to suit a particular trade. For example, canopies for the vending of fast food at a work site are of a particular design whereas canopies used by electricians and plumbers are naturally of a more customised configuration particular to the trade.

In order to manufacture the canopy, a mould has to be constructed which is also a very expensive process. Individual moulds have to be constructed and configured for each different type of trade. Suppliers and manufacturers of canopies have to have an inventory of various moulds. This is a very expensive business investment for a canopy manufacturer and does not enable the ready or easy customisation of the moulds to suit a particular customer's requirements.

In addition, the problem of increasing or decreasing the size of the canopy, for example increasing the length of the canopy while retaining the general configuration, is not possible with the current state of prior art. Permanent moulds of canopies specifically crafted for various types of trucks or utility vehicles are not easily adapted or modified to suit alternative makes of vehicles or vehicle type.

There is therefore a need for a solution to the present problem wherein the configurations of canopies can be varied to suit the application and type or size or make of vehicle.

There is also an additional problem wherein the packaging of prior art canopies for transport or export is determined by the size and weight of the canopy. The present invention provides modules or sections which can be partially assembled or finally assembled at the destination thereby reducing container and freight costs for the obvious reasons.

Furthermore, damage to a portion of a prior art canopy when in use is not easily repaired by simply replacing the portion which has been damaged. Current practice of repairing localised damage to a canopy can also result in being detrimental to the structural integrity of the whole canopy.

### OBJECT OF THE INVENTION

It is therefore an object of the present invention to seek to ameliorate some or all of the disadvantages of the prior art or to at least provide the public with a useful choice.

### STATEMENT OF THE INVENTION

In one aspect therefore, the invention resides in canopy of modular construction including in combination,

a plurality of modules which can be assembled together to construct a canopy for a truck or utility vehicle,

said modules interchangeable to vary the size, length and configuration to suit a type of trade or business.

Preferably a roof panel is of a fixed size and the variation to the canopy is a function of the modules not comprising the roof panel.

Preferably the modules and the roof panel are constructed of glass reinforced plastic or fibreglass or an equivalent material.

Preferably the modules are assembled together by having complementary grooves or channels such that the modules are joined together to achieve a flush fitting contributing to the water resistance of the canopy.

Preferably the assembled modules can be disassembled and replaced with other modules in the event of damage to a particular module or to alter the configuration of the canopy.

Preferably the modules are joined together by inert metal fastenings and can include the use of gaskets or adhesives where required.

Preferably, complementary grooves or channels are also used for fitting of hinged doors or covers to prevent the ingress of water and to provide a flush fitting resulting in a smooth exterior surface of the canopy.

Preferably where windows are used, the windows are bonded and recessed into the canopy modules resulting in a flush finish.

### BRIEF DESCRIPTION OF THE DRAWINGS

In order for the invention to be better understood and put into practical effect, reference will now be made to the accompanying drawings wherein:

FIG. 1 shows an exploded view of a preferred canopy of the invention,

FIG. 2 shows a top perspective view of the canopy of FIG. 1, fully assembled, and

FIG. 3 shows a bottom perspective view of the canopy of FIG. 2.

### DETAILED DESCRIPTION OF THE DRAWINGS

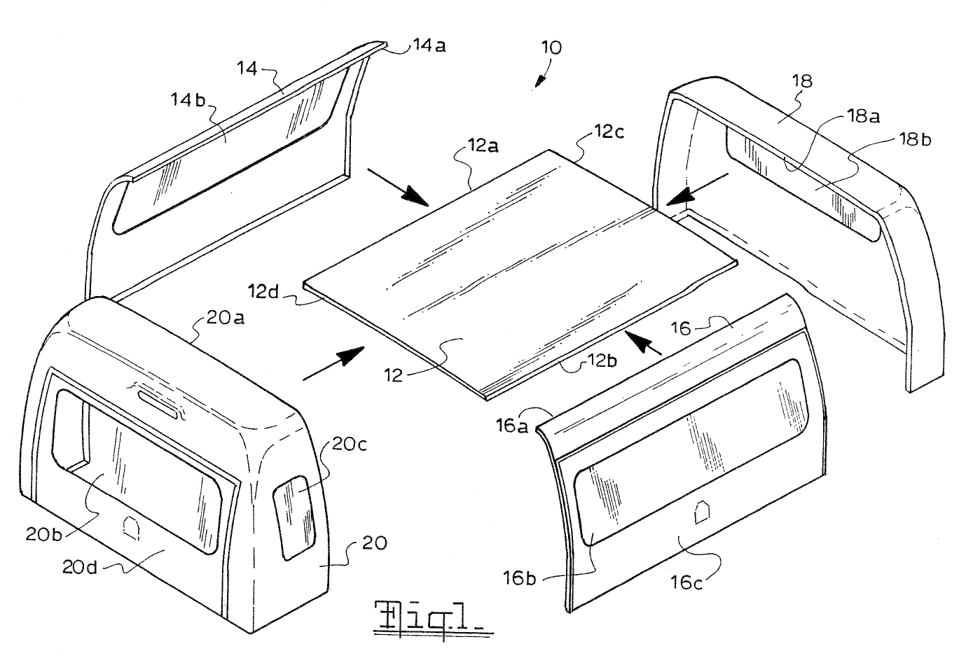

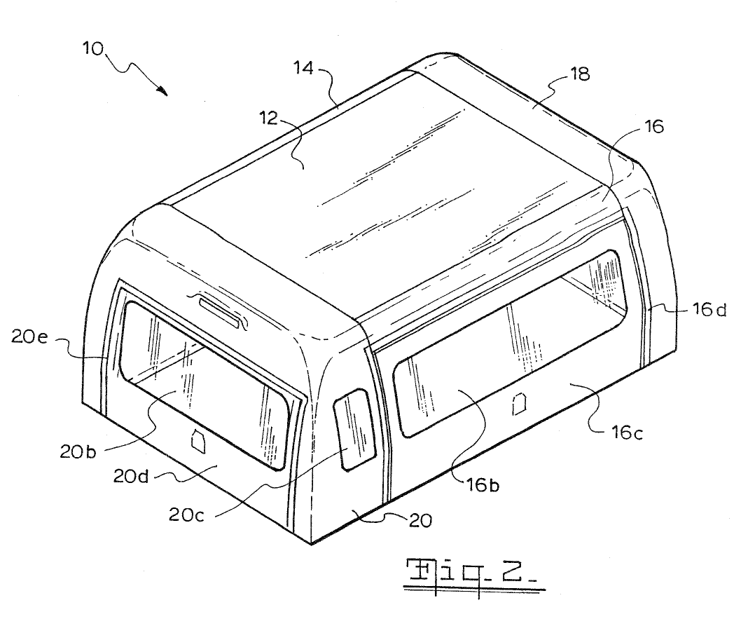

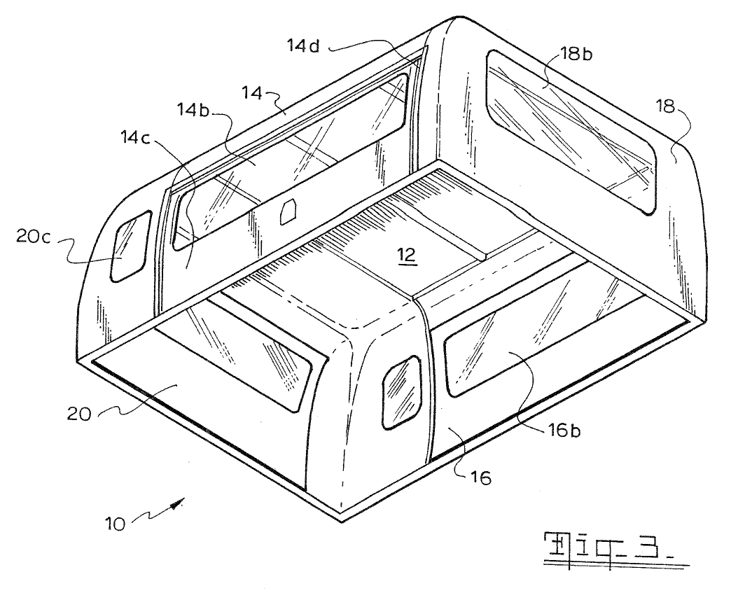

Referring to the drawings and to FIGS. 1 to 3 there is shown a preferred modular canopy 10 according to the invention. FIG. 1 is an exploded view of the canopy. FIGS. 2 and 3 show top and bottom perspectives of the canopy fully assembled. In all three representations, the same and or consistent numbering system has been used to enumerate and identify identical or analogous parts and views.

FIG. 1 shows the canopy 10 comprising a roof section 12 or panel, a left 14 and a right side 16 section, a front 18 and a rear 20 section. The sections or modules are joined together as shown in FIGS. 2 and 3 by inter-engaging grooves 12a, 12b, 12c, 12d on the roof panel and 14a, 16a, 18a, 20a on the separate modules or channels which provide flush fitting joins resulting in a smooth exterior surface.

This is an obvious advantage in increasing both the water resistance and aerodynamic characteristics of the canopy. The separate modules are preferably joined by screws and/or rivets of stainless steel or aluminium or other inert metal. Gaskets and seals and adhesives can also be used in the assembly. It will be obvious to the skilled addressee that the canopy can also be disassembled either completely or partially such as when a particular module is damaged and is replaced.

As previously discussed, preferably, the roof panel 12 is supplied as a fixed size component and the side 14, 16 and end 18, 20 modules are used to vary the shape and configuration of the assembled canopy. The doors 14c, 16c, 20d have rubber seals 14d, 16d, 20e and windows 14b, 16b, 18b, 20b, 20c are also bonded and recessed into the canopy modules to contribute to a flush fitting resulting in a smooth exterior.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A modular canopy including in combination,
a plurality of modules which can be assembled together to construct a canopy for a truck or utility vehicle,
said modules interchangeable to vary the size, length and configuration to suit a type of trade or business.

2. A modular canopy as claimed in claim 1, wherein a roof panel is of a fixed size and the variation to the canopy is a function of the modules not comprising the roof panel.

3. A modular canopy as claimed in claim 1, wherein the modules and the roof panel are constructed of glass reinforced plastic or fiberglass or an equivalent material.

4. A modular canopy as claimed in claim 1, wherein the modules are assembled together by having complementary grooves or channels such that the modules are joined together to achieve a flush fitting contributing to the water resistance of the canopy.

5. A modular canopy as claimed in claim 1, wherein the modules can be disassembled and replaced with other modules in the event of damage to a particular module or to alter the configuration of the canopy.

6. A modular canopy as claimed in claim 1, wherein the modules are joined together by inert material fastenings and can include the use of gaskets or adhesives where required.

7. A modular canopy as claimed in claim 1, wherein complementary grooves or channels are used for fitting of hinged doors or covers to prevent the ingress of water and to provide a flush fitting resulting in a smooth exterior surface of the canopy.

8. A modular canopy as claimed in claim 1, wherein windows are bonded and recessed into the canopy modules resulting in a flush finish.

9. A modular canopy as claimed in claim 2, wherein the modules and the roof panel are constructed of glass reinforced plastic or fiberglass or an equivalent material.
